(19) United States
(12) Patent Application Publication
(10) Pub. No.: US 2007/0089107 A1
(43) Pub. Date: Apr. 19, 2007

(54) DATABASE COMMUNICATION METHOD

(76) Inventors: Steve SQUIRES, New South Wales (AU); Gary Brabiner, New South Wales (AU); Ken Holloway, New South Wales (AU); Tom Rusnak, New South Wales (AU)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/539,408

(22) Filed: Oct. 6, 2006

(30) Foreign Application Priority Data
Oct. 10, 2005 (AU) 2005905572
Oct. 17, 2005 (AU) 2005905735

(51) Int. Cl. G06F 9/44

(52) U.S. Cl. 717/162

(57) ABSTRACT

This invention provides a method of intercepting a call to a database, such as a DB2 SQL call in batch, CICS, and TSO environments, and routing the call to a DB2 subsystem running in another partition (LPAR) such as a Z/OS partition or another Z/OS mainframe and then transmitting the results back to the originating program. A call is intercepted and redirected to a database in the second LPAR or mainframe. This processing is done transparently to the calling program and transparently to DB2. This allows the administrator to configure the application programming and the DB2 subsystems into separate LPARs or machines.

### FIELD OF THE INVENTION

This invention relates to a method of enabling a software application to access database management software.

The invention can be applied to software executing on International Business Machine (IBM) mainframe computers. It is applicable to IBM's operating system known as Z/OS. The invention will be described with reference to IBM's database management software known as DB2.

### DESCRIPTION OF THE RELATED ART

IBM Corporation has developed a database environment used on its mainframe computers referred to as DB2. The DB2 software can be executed on different IBM operating systems. The predominant operating system for DB2 is known as Z/OS. Application programs access DB2 data using Structured Query Language (SQL). SQL is the de facto standard for Relational Database Management Systems of which DB2 is the most widely used on the IBM mainframe.

SQL is used to query information, and to modify, insert and delete data. The SQL statements within a DB2 program need to be processed, either with the DB2 precompiler or an SQL statement coprocessor that is provided with a compiler. The SQL statement processor replaces the SQL text with calls to DB2 language interface modules. After an SQL statement is processed in the source program using the DB2 precompiler, a load module is created. Creating a load module involves compiling the modified source code that is produced by the precompiler into an object program, and link-editing the object program.

When the application program executes, communication between the application and DB2 is provided by DB2 attachment facilities which run as part of the application's address space. The attachment facilities that communicate to DB2 include:

CICS attachment facility (CA)

IMS attachment facility (IA)

Call attachment facility (CAF)

TSO attachment facility (TA)

It is a requirement of the DB2 software that the attachment facilities are executing on the same computer as the DB2 subsystem.

Furthermore, IBM mainframe computers can be logically divided into Logical Partitions (LPARS). An LPAR is a subset of a single system that contains resources (processors, memory and input/output devices). An LPAR operates as an independent system. If hardware requirements are met, multiple LPARs can exist within a mainframe complex.

On a machine which contains logical partitions, it is also a requirement that the attachment facility executes on the same LPAR as the DB2 subsystem.

### SUMMARY OF THE INVENTION

This invention provides a process that allows the attachment facilities to connect to a DB2 subsystem on a different machine or LPAR. This allows more flexibility, and more options for balancing the workload of the different LPARs. The process can be implemented by the use of mediating software which redirects queries directed from a requesting program to a local database to a non-local database, and provides responses from the non-local database to the requesting program.

According to an embodiment of the invention, there is provided a method of enabling an originating program in a first logical partition or first machine to access database management software in a second logical partition or machine, the method including the steps of:
intercepting calls from an originating program to a database in the first logical partition or first machine;
redirecting the call to a database in a second LPAR or machine, and
redirecting the results back to the originating program.

The invention also provides a method of enabling an originating program in a first logical partition or first machine to access database management software in a second logical partition or second machine, the method including the steps of:
intercepting a call from an originating program to a database;
transporting information relating to the call to software running in a second LPAR or machine;
issuing the call to a database in a second LPAR or machine, and
redirecting the results back to the originating program.

The method can be implemented by mediating software, wherein the step of intercepting a call is accomplished by creating a PC call environment pointing to a module which is controlled by, or forms part of, the mediating software.

The calls from the originating program can be calls to a local DB2 SQL sub-system, and wherein, after creating the PC call environment, the calls are controlled by the mediating software.

The method can include the step of relocating the SQL request to a database in the second LPAR or machine.

The SQL call can include an SQL parameter list.

The method can include the steps of:
analysing the contents of the SQL parameter list;
incorporating parameters that are input to the call (input host variables) into a transport message; and
transmitting the transport message to a destination partition or machine.

The method can include the steps of accumulating the lengths of any output host variables and incorporating the accumulated length into the transport message.

The method can include the step of transporting the transport message using a network protocol or other protocol for communicating across partitions.

The protocol can be TCP/IP.

The method can include the step of decomposing the transport message back to the original SQL request at the destination.

The method can include the step of executing the SQL message against the DB2 subsystem at the destination.

The step of intercepting can be done transparently to the originating program.

The step of redirecting the results can be done transparently to the originating program.

The steps of intercepting and redirecting can be done transparently to the DB2 subsystem.

### SUMMARY OF FIGURES

FIG. 1 illustrates the “traditional” concept of an SQL call made to a local DB2 subsystem.

FIG. 2 illustrates an SQL request made from Program A on a local LPAR is transported across to a DB2 system “DB2A” running on a remote LPAR.

FIG. 3 illustrates finding the DB2 subsystem code in the traditional environment where a DB2 subsystem is executing on a local partition.

FIG. 4 illustrates the replacing of the address of the DB2 subsystem code by a pointer.

FIG. 5 illustrates the standard format of an SQL request parameter list.

FIG. 6 illustrates the copying of PVAR SQLDA into a transport buffer, followed by the actual PVAR data contents.

FIG. 7 illustrates the copying of the AVAR SQLDA into the transport buffer.

FIG. 8 illustrates the extraction of information from the requesting job and placing it in the transport buffer.

FIG. 9 illustrates changing offsets in the PLIST and PVAR SQLDA to virtual addresses.

FIG. 10 illustrates acquiring empty memory for the AVARs and updating the AVAR SQLDA.

FIG. 11 illustrates the AVAR data and SQLCA becoming the new transport buffer to be sent back to the local system

### DETAILED DESCRIPTION OF AN EMBODIMENT OF THE INVENTION

According to a first embodiment of this invention, a call to a database, such as a DB2 SQL call in batch, CICS, and TSO environments, is intercepted and routed to a DB2 subsystem running in another partition (LPAR) such as a Z/OS partition or another Z/OS mainframe and then the results are transmitted back to the originating program. A call is intercepted by creating a PC call environment to redirect the call to a database in the second LPAR or mainframe. This processing is done transparently to the calling program and transparently to DB2. This allows the administrator to configure the application programming and the DB2 subsystems into separate LPARs or machines.

The invention allows other applications to access DB2 from outside of the Logical Partition (LPAR) where DB2 is executing.

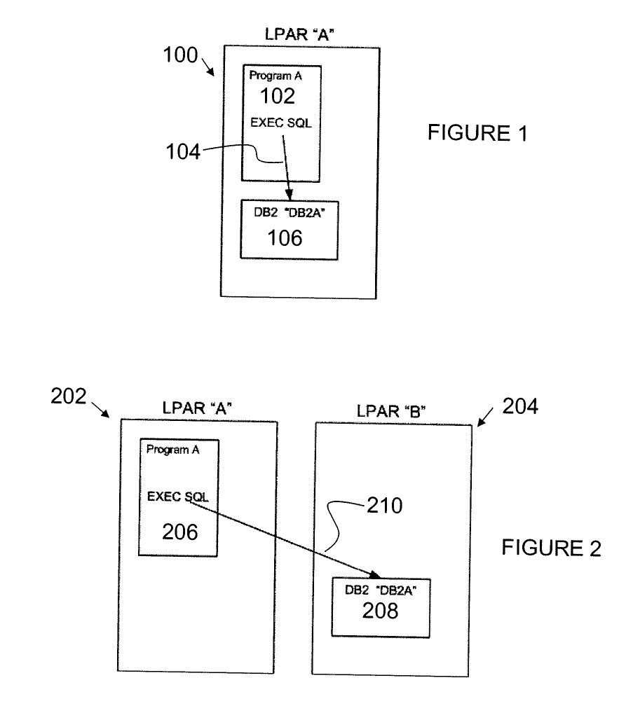

As shown in FIG. 1, an application program 102 and database subsystem 106 are contained in a single LPAR “A” 100. The traditional SQL call 104 is made via a DB2 attachment facility to the local DB2 subsystem 106 running in the same partition 100 on the same machine.

As shown in FIG. 2, the invention enables a program executing in a first partition 202 to execute SQL requests 210 against a DB2 subsystem 208 in a second remote partition 204. The first partition can be considered as a local partition, and the second partition can be considered as a remote partition. The partitions can include segments of one machine, or separate machines.

“Local partition” is herein defined as the LPAR or machine where the SQL is executed through one of the DB2 attachment facilities. In FIG. 2 this is depicted as LPAR “A” 202.

“Remote partition” is defined as the LPAR or machine where the DB2 subsystem actually resides. In FIG. 2, this is depicted as LPAR “B” 204.

The invention provides the ability to “intercept” a DB2 request from an attachment facility transparently, that is, without any evidence that the request is not being processed by a local DB2 subsystem.

This is accomplished by replacing the pointer in the subsystem vector table which normally points to a module supplied as part of the DB2 subsystem. The pointer is updated to point to a module belonging to or controlled by mediating software according to an embodiment of the invention. From then onwards, whenever a DB2 SQL call is made towards a local DB2 subsystem, part of the inventive software will gain control of the SQL request instead.

The invention also provides the ability to relocate the SQL request to another partition or machine to be processed by a DB2 subsystem in that environment. This is done by analysing the contents of the SQL parameter list. Any “input host variables”, i.e., parameters that are input to the call, are built into a transport message. For any “output host variables”, the lengths are accumulated and that length becomes part of the transport message. The message is then transmitted using a standard network protocol such as TCP/IP to another partition or machine. A program listening on a TCP/IP port on that partition or machine then decomposes the transport message back into the original SQL request for execution against a DB2 subsystem that is now local to the request.

The administrator of the inventive software will code a set of parameters that will be used to control execution of DB2 SQL requests on this LPAR. A typical mainframe installation may have one or more DB2 subsystems executing on any particular LPAR. It may be desirable to route the SQL requests for one, many, or all DB2 subsystems on a particular LPAR to one or many other LPARs. The name of the DB2 subsystems to “intercept” and the location of the remote partition both need to be communicated to the inventive software. The location of the remote LPAR is coded as a standard TCP/IP location.

A job is then executed using the coded input parameters. This job then acts as the main controller for the invention executing on this local LPAR.

It is possible that a local partition can also act as a remote partition for other DB2 subsystems.

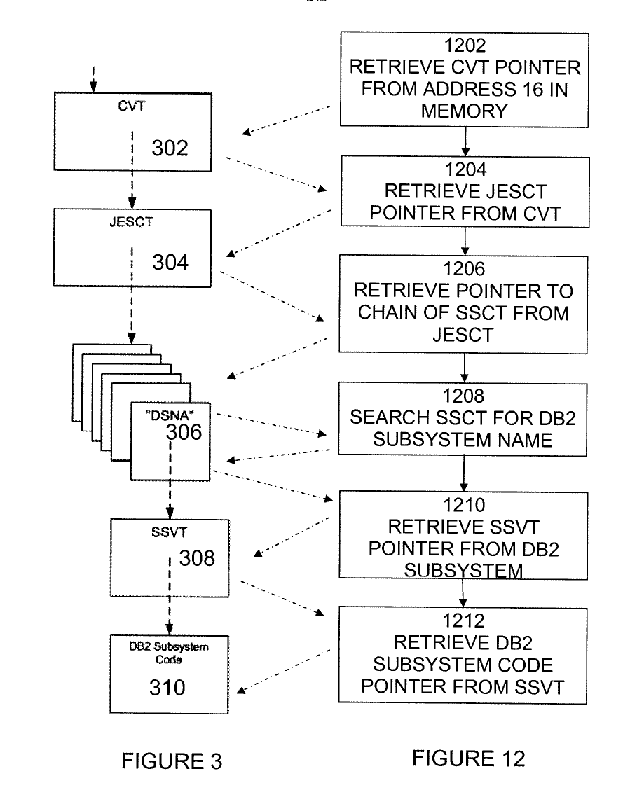

This controlling job also plants the “intercepts” for any selected DB2 subsystems. FIG. 3 illustrates a method of finding the address of the DB2 subsystem code. Looking at a traditional DB2 subsystem executing on a local partition, the address of the DB2 subsystem code can be found by following the control block “chain” to find the Subsystem Vector Table (SSVT) for the DB2 subsystem. The SSVT then has a pointer to the subsystem code that is executed by DB2 after a subsystem request.

In FIG. 3, address 16 in memory contains a pointer to the Communications Vector Table (CVT) 302. The CVT contains a pointer to the JESCT 304. The JESCT contains a pointer to a chain of Subsystem Control Tables (SSCT) 306, one for each defined subsystem. The SSCTs are searched until the required DB2 subsystem name is found. This SSCT include a pointer to the Subsystem Vector Table (SSVT) 308.

The SSVT contains the address of the DB2 subsystem code 310.

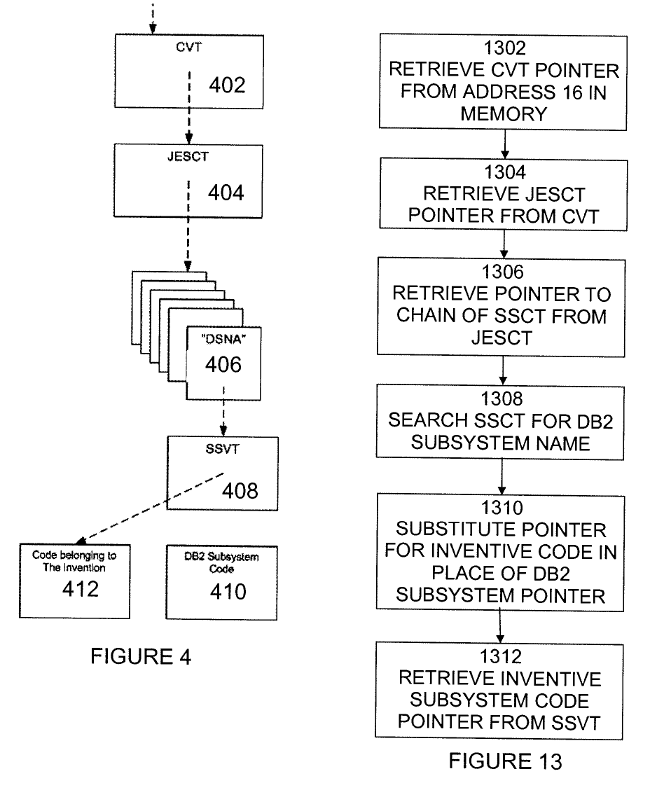

In a method embodying the invention, the DB2 Subsystem Code 310 is replaced by code belonging to the novel software. This “intercept” allows the real DB2 subsystem to be located at a remote partition. Any SQL requests that are made for the selected DB2 subsystem are instead intercepted and processed by code belonging to the novel software as shown in FIG. 4.

In FIG. 4, the pointer to the CVT 402 is retrieved from the address 16 in memory, and this provides a pointer to the JESCT 404, which in turn provides a pointer to the SSCT 406. The SSCT is searched for the required DB2 subsystem name 406. The SSCT for the DB2 subsystem 406 provides the pointer for the SSVT 408 for the DB2 subsystem 406. In accordance with the embodiment of the invention, the pointer from SSVT 408 to the DB2 Subsystem Code is then substituted by a pointer to code provided by the novel software.

If there is not an existing subsystem definition for the DB2 that is to be intercepted, then a subsystem is defined using the standard IEFSSVT macro. Function codes are set to “listen” for the “Identify” requestion (Function 41).

The code also sets up a stacking PC Call environment. This environment is used to gain control on a DB2/SQL request.

Once the intercept is in place the mediating software is enabled but remains dormant until one of the DB2 attachment facilities attempts to communicate a request to one of the DB2 subsystems that are being monitored by the mediating software. A DB2 attachment facility issues a subsystem “Identify” call as the initial call to identify itself as a requestor to a DB2 subsystem.

Once the subsystem has been built or code placed into an existing subsystem structure, then those “Identify” calls made by one of the DB2 attachment facilities execute code belonging to the mediating software. The code then extracts information from field SSOBINDV in the subsystem options block(SSOB) which contains a pointer to the Function Request Block(FRB). The code then issues a PC Call passing the FRB address as a parameter, emulating the PC Call made by the attachment facility.

Once the intercept is activated and the code of the novel software is executing, the FRB is interrogated to determine the type of request, for example SQL call, DB2 command, or Connection Control. Depending on the type of request, different information is placed in a transport buffer. If it is an SQL request then the SQL parameter list is decomposed for placement in a transport buffer. If the request is to “Connect” to a DB2 subsystem then information about the requesting job, started task, or TSO session is gathered and packaged in a transport buffer. This includes, but is not limited to, jobname, accounting information, programmer-name, jobclass, message class and RACF identification(or equivalent). This information is sent to the controlling task on the remote partition where DB2 is executing. The controlling task then creates a “Clone” job or started task using as much information as possible from the originating requester. The existence of this clone job aids with the transparency so that the DB2 subsystem is able to recognize the same authorities as the original requester and is also able to chargeback the CPU utilization to a job with the same security (RACF or equivalent) as the original requester.

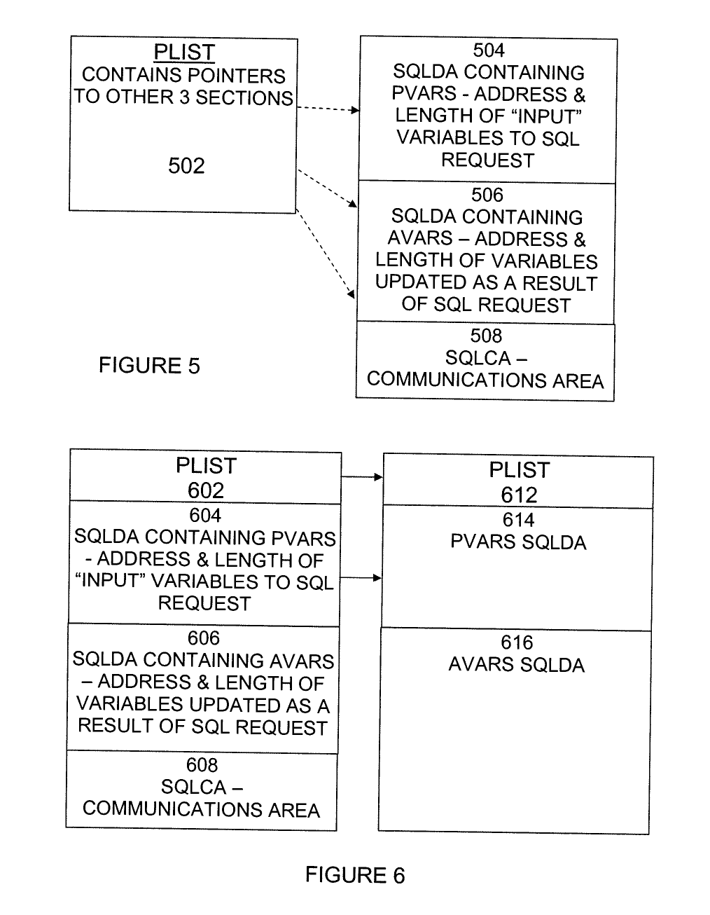

A standard SQL parameter list is comprised of up to four sections as shown in FIG. 5. The PLIST 502 contains information about the requester as well as pointers to the other three sections. The SQLDA for PVARS 504 contains information about variables that are input to the SQL request. The length, type and address of these host variables are kept in this area.

The SQLDA for AVARS 506 contains information about variables that are to contain the results of the SQL request. The length, type and address of these host variables are kept in this area.

The fourth section is the SQL Communications area (SQLCA) 508. An SQLCA is a collection of variables that is updated at the end of the execution of every SQL statement.

The following description covers the majority of SQL calls. However there are some circumstances where different actions are taken. In all cases the basis of data movement remains the same.

A shown in FIG. 6, the PLIST 602 is copied into a transport buffer 610 at 612 with addresses changed to offsets relative to the beginning of the transport buffer.

The PVAR SQLDA 604 is copied into the transport buffer 610 at 614, followed by the actual contents of each variable at 616 as illustrated in FIG. 6. Addresses in the SQLDA are changed to offsets to the data, relative to the beginning of the transport buffer.

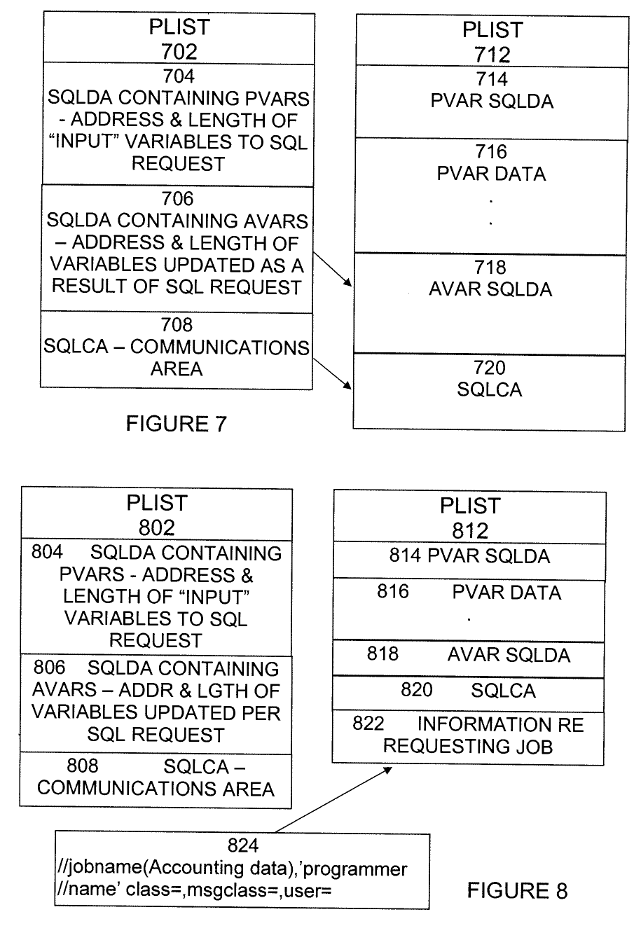

As shown in FIG. 7, the AVAR SQLDA 706 is copied into the transport buffer 710. The data values are not copied.

The content of the SQLCA 708 is then added unchanged to the transport buffer at 720.

If this is an “OPEN” request or the first request, then information regarding the requesting job 824 is included in the buffer at 822 in FIG. 8. This can include jobname, job accounting details, programmer name, job execution class, job message class and security userid.

The transport buffer is then sent to the remote partition using a standard networking protocol such as TCP/IP.

Code belonging to the novel software, executing in the remote partition, then analyses the transport buffer in order to create a “clone” of the original SQL request and requester.

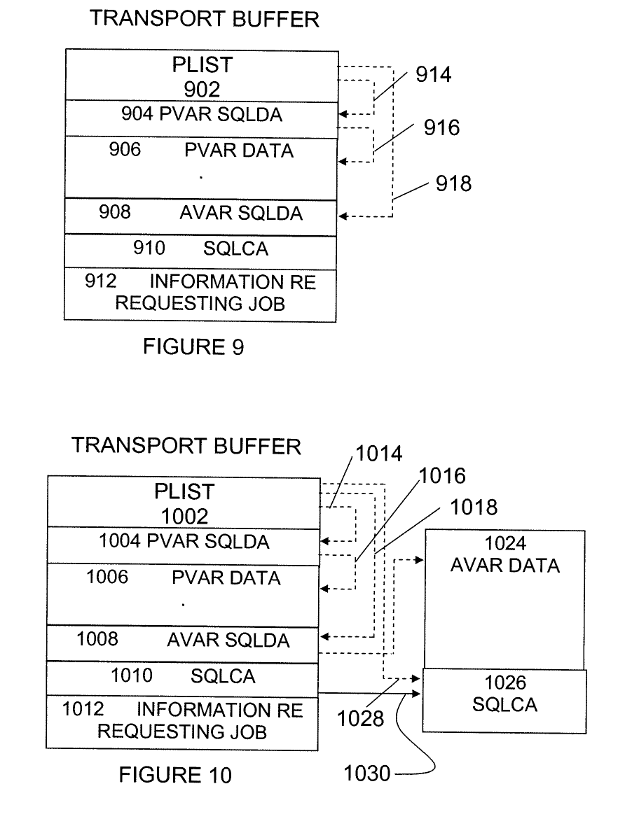

As shown in FIG. 9, the offsets in the PLIST are changed to virtual addresses.

An empty area is acquired for each of the AVARs. The AVAR SQLDA 908 is then updated to point to addresses within the newly acquired memory area.

As shown in FIG. 10, the SQLCA 1010 is copied to an area 1026 following the AVAR data 1024.

Information about the originating requester is then used to construct a “clone” job on the remote partition. This job will have as many attributes and security authorities as can be determined of the originating requester on the local partition. However, instead of this cloned job executing the original application program it is instead executing code belonging to the mediating software. This code interrogates the transport buffer and takes action to execute the request against the real DB2 subsystem. First of all the code issues the “Identify” subsystem request. This code then executes the DB2 command, Connection request or SQL request using information from the transport buffer or the newly built SQL parameter list. This is accomplished by creating a clone of the FRB from the original application request. This FRB is then passed as a parameter to DB2 by issuing a PC Call. This request is then processed by the DB2 subsystem on the remote partition.

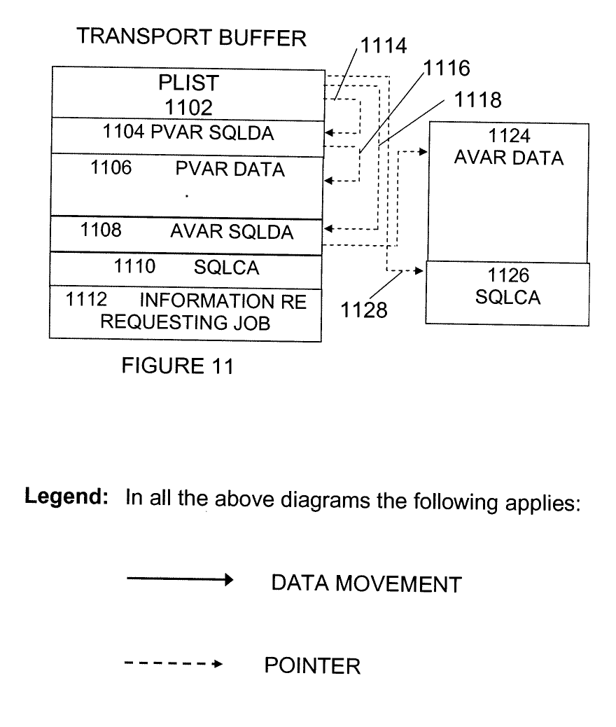

After execution of the SQL request, the contents of the AVARs, as well as the SQLCA, are sent back to the local partition as shown in FIG. 11. In most cases there is no requirement to send either the PLIST or the PVARs back, as they do not get modified as a result of an SQL request.

The AVARs from the transport buffer are then copied into the location of the original host variables pointed to by the SQLDA for AVARs in the SQL parameter list. The contents of the SQLCA are also copied into the original SQLCA.

Control is then returned to the original application program. The application program will now see the same results as if the SQL request was made to a local DB2 subsystem executing on the local partition.

While the invention has been described with reference to a particular embodiment, the invention can be applied to various other embodiments without departing from the inventive concept.

1. A method of enabling an originating program in a first logical partition or first machine to access database management software in a second logical partition or machine, the method including the steps of:
intercepting calls from an originating program to a database in the first logical partition or first machine;
redirecting the call to a database in a second LPAR or machine, and redirecting the results back to the originating program.

2. A method of enabling an originating program in a first logical partition or first machine to access database management software in a second logical partition or second machine, the method including the steps of:
intercepting a call from an originating program to a database; transporting information relating to the call to software running in a second LPAR or machine;
issuing the call to a database in a second LPAR or machine, and
redirecting the results back to the originating program.

3. A method as claimed in claim 2 implemented by mediating software, wherein the step of intercepting a call includes the step creating a PC call environment pointing to a module which is controlled by, or forms part of, the mediating software.

4. A method as claimed in claim 3, wherein the calls from the originating program are calls to a local DB2 SQL sub-system, and wherein, after the step of substituting a pointer, the calls are controlled by the mediating software.

5. A method as claimed in claim 2, including the step of relocating the SQL request to a database in the second LPAR or machine.

6. A method as claimed in claim 4, wherein the SQL call includes an SQL parameter list, the method including:
analyzing the contents of the SQL parameter list;
incorporating parameters that are input to the call (input host variables) into a transport message; and
transmitting the transport message to a destination partition or machine.

7. A method as claimed in claim 6, including the step of accumulating the lengths of any output host variables and incorporating the accumulated length into the transport message.

8. A method as claimed in claim 6, including the step of transporting the transport message using a network protocol or other protocol for communicating across partitions.

9. A method as claimed in claim 8, wherein the protocol is TCP/IP.

10. A method as claimed in claim 6, including the step of decomposing the transport message back to the original SQL request at the destination.

11. A method as claimed in claim 10, including the step of executing the SQL message against the DB2 subsystem at the destination.

12. A method as claimed in claim 1, wherein the step of intercepting is done transparently to the originating program.

13. A method as claimed in claim 1 wherein the step of redirecting the results is done transparently to the originating program.

14. A method as claimed in claim 1, wherein the steps of intercepting and redirecting are done transparently to the DB2 subsystem.

15. A method of enabling an originating program in a first logical partition or first machine to access database management software in a second logical partition or second machine, substantially as herein described with reference to the accompanying drawings.

16. A computer system adapted to implement the method of claim 1.

17. A computer system including a first logical partition or a first machine and a second logical partition or machine, the system being adapted to enable an originating program in the first logical partition or first machine to access database management software in the second logical partition or machine, the system being adapted to
intercept calls from an originating program to a database in the first logical partition or first machine;
redirect the call to a database in a second LPAR or machine, and
redirect the results back to the originating program.

18. (canceled)
